(19) United States
(12) Patent Application Publication
(10) Pub. No.: US 2022/0312790 A1
(43) Pub. Date: Oct. 6, 2022

(54) COMPOSITION, SYSTEM, AND METHOD FOR MAKING A WHIPPED COFFEE CONCENTRATE

(71) Applicant: Java Nova Co LLC, Pittsburgh, PA (US)

(72) Inventors: Merhan H. WAHBY, Easton, PA (US); Ahmed F. HOSNY, Easton, PA (US)

(73) Assignee: Java Nova Co LLC, Pittsburgh, PA (US)

(21) Appl. No.: 17/714,497

(22) Filed: Apr. 6, 2022

Related U.S. Application Data
(60) Provisional application No. 63/171,491, filed on Apr. 6, 2021.

(51) Int. Cl. A23F 5/24; A23F 5/40; A23P 30/40

(52) U.S. Cl. CPC A23F 5/243; A23F 5/40; A23P 30/40

(57) ABSTRACT

Compositions, systems, and methods for making a whipped beverage concentrate are disclosed. A method for producing a whipped beverage concentrate may include creating a base mixture comprising at least two ingredients, wherein the at least two ingredients includes an instant drink mix. The method may further include inserting the base mixture into a canister, wherein the canister is configured to dispense nitrous oxide into the base mixture. The method may additionally include initiating release of nitrous oxide into the base mixture, thereby creating a whipped beverage concentrate configured for dispensing from the canister.

### CROSS-REFERENCE TO RELATED APPLICATION

This application claims priority to U.S. Provisional Application No. 63/171,491 filed Apr. 6, 2021, which is incorporated herein by reference.

### TECHNICAL FIELD

This disclosure generally relates to beverages, and in particular, to compositions, systems, and methods for making a whipped beverage concentrate, such as a whipped beverage concentrate for a dalgona coffee beverage.

### BACKGROUND

Whipped beverages may be time-consuming to make. For example, certain coffee-based beverages can be made to a consumer's desired taste to alleviate the need to add milk, cream, half and half, or non-dairy substitute such as soy milk, almond milk, or Coffeemate™. If a consumer desires a whipped beverage, such as a dalgona coffee beverage, the consumer or a barista may combine a variety of ingredients into a mixture, apply a mixer to the mixture until a relatively thick, whipped foam develops containing a beverage concentrate, and then scoop the whipped beverage concentrate into a container, such as a glass. In some instances, such as when an electric mixer is used, the electric mixer is applied to the mixture for a relatively long time, usually several minutes, before a thick, whipped foam develops containing a beverage concentrate. In other instances, such as when a hand mixer is used, the hand mixer is applied to the mixture for an even longer time, usually about 10-15 minutes, before a thick, whipped foam develops containing a beverage concentrate. Further, the electric mixing or further hand mixing may have to be repeated if a second beverage with a whipped beverage concentrate is desired at a later time, because the thick, whipped foam may lose some of its structure over time. The relatively time-consuming method of making a whipped beverage can thus be off-putting to consumers. In addition, the use of an appliance such as an electric mixer or a hand mixer may be relatively messy and may require additional time to clean the various beverage making equipment.

### SUMMARY OF THE DISCLOSURE

Compositions, systems, and methods for making a whipped beverage concentrate are disclosed. In various embodiments, a composition and system for making a whipped beverage concentrate can be provided. In various embodiments, a method for making a whipped beverage concentrate can be provided.

In various embodiments, a method for producing a whipped beverage concentrate can include creating a base mixture including at least two ingredients, wherein the at least two ingredients includes an instant drink mix. The method for producing a whipped beverage concentrate can further include inserting the base mixture into a canister, wherein the canister is configured to dispense nitrous oxide into the base mixture. The method for producing a whipped beverage concentrate can additionally include initiating release of nitrous oxide into the base mixture, thereby creating a whipped beverage concentrate configured for dispensing from the canister.

In various embodiments, the base mixture can include at least the instant drink mix and boiling or near boiling water in equal parts. In various embodiments, the instant drink mix is at least one of an instant coffee, an instant espresso, a dehydrated chocolate or cocoa, a dehydrated tea, or another instant drink mix. In various embodiments, the instant coffee may include dehydrated brewed coffee, and the instant espresso may comprise dehydrated brewed espresso.

In various embodiments, the at least two ingredients are dissolved or nearly dissolved in the base mixture.

In various embodiments, the method of producing a whipped beverage concentrate can include dispensing the whipped beverage concentrate into a container comprising water, milk, cream, half and half, alcohol, non-dairy substitute, flavors, and/or other ingredients.

In various embodiments, the canister can comprise an aerosol canister, a keg, or a whipped cream canister.

In various embodiments, the canister containing the base mixture can be stored in a refrigerated environment.

In various embodiments of a system for making a whipped beverage concentrate, the system can include a canister, wherein the canister is configured to receive a base mixture, the base mixture comprising at least two ingredients, and wherein the at least two ingredients includes an instant drink mix. The canister may be further configured to initiate release of nitrous oxide into the base mixture, thereby creating a whipped beverage concentrate, and to dispense the whipped beverage concentrate from the canister.

In various embodiments, the base mixture can include at least the instant drink mix and water. In various embodiments, the instant drink mix is at least one of an instant coffee, an instant espresso, a dehydrated chocolate or cocoa, a dehydrated tea, or another instant drink mix. In various embodiments, the instant coffee can comprise dehydrated brewed coffee, and the instant espresso can comprise dehydrated brewed espresso.

In various embodiments, the at least two ingredients can be dissolved or nearly dissolved in the base mixture.

In various embodiments, the canister can be further configured to dispense the whipped beverage concentrate from the canister into a container containing water, milk, cream, half and half, alcohol, non-dairy substitute, flavors, and/or other ingredients.

In various embodiments, the canister can include an aerosol canister, a keg, or a whipped cream dispenser.

In various embodiments of a whipped beverage composition, the composition may include a base mixture comprising at least an instant drink mix and water and nitrous oxide, wherein the nitrous oxide is mixed with the base mixture, thereby resulting in a whipped beverage concentrate.

In various embodiments, the instant drink mix is at least one of instant coffee, instant espresso, a dehydrated chocolate or cocoa, a dehydrated tea, or another instant drink mix.

In various embodiments, the base mixture can be received in a canister, and the canister can be configured to dispense the nitrous oxide into the base mixture. In various embodiments, the canister may include an aerosol canister, a keg, or a whipped cream dispenser.

In various embodiments, the base mixture can be dispensed into a container comprising water, milk, cream, half and half, alcohol, non-dairy substitute, flavors, and/or other ingredients.

Additional compositions, systems, methods, features, and aspects are realized through the techniques of various embodiments of the disclosure. Other embodiments and aspects of the disclosure are described in detail herein and are considered a part of the claimed subject matter. Other features can be understood and will become apparent with reference to the description and to the drawings.

### BRIEF DESCRIPTION OF THE DRAWINGS

The drawings are provided for purposes of illustration only and merely depict example embodiments of the disclosure. The drawings are provided to facilitate understanding of the disclosure and shall not be deemed to limit the breadth, scope, or applicability of the disclosure. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

FIG. 1 illustrates an example system and composition for creating a mixture for a whipped beverage concentrate, in accordance with an embodiment of the disclosure.

FIG. 2 illustrates an example system and composition for loading the mixture of FIG. 1 into a commercially available canister to dispense the whipped beverage concentrate, in accordance with an embodiment of the disclosure.

FIG. 3 illustrates an example system and composition for using the mixture of FIG. 1 to produce a whipped beverage concentrate, in accordance with an embodiment of the disclosure.

FIG. 4 illustrates another example system and composition for dispensing a whipped beverage from a canister, in accordance with an embodiment of the disclosure.

FIG. 5 illustrates a block flow diagram of an example method and composition for producing a whipped beverage concentrate, in accordance with an embodiment of the disclosure.

This disclosure will now provide a more detailed and specific description that will refer to the accompanying drawings. The drawings and specific descriptions of the drawings, as well as any specific or alternative embodiments discussed, are intended to be read in conjunction with the entirety of this disclosure.

### DETAILED DESCRIPTION

This disclosure relates to, among other things, compositions, systems, and methods for making a whipped beverage concentrate. In one embodiment, a composition and system for making a whipped beverage concentrate can be provided. In another embodiment, a method for making a whipped beverage concentrate can be provided.

In one example embodiment, a method for producing a whipped beverage concentrate can include creating a base mixture including at least two ingredients, wherein the at least two ingredients includes an instant drink mix. The method for producing a whipped beverage concentrate can further include inserting the base mixture into a canister, wherein the canister is configured to dispense nitrous oxide into the base mixture. The method for producing a whipped beverage concentrate can additionally include initiating release of nitrous oxide into the base mixture, thereby creating a whipped beverage concentrate configured for dispensing from the canister.

In one embodiment, the base mixture can include at least the instant drink mix and water. In one embodiment, the instant drink mix is at least one of an instant coffee, an instant espresso, a dehydrated chocolate or cocoa, a dehydrated tea, or another instant drink mix. In one embodiment, the instant coffee may include dehydrated brewed coffee, and the instant espresso may include dehydrated brewed espresso.

In one embodiment, the at least two ingredients are dissolved or nearly dissolved in the base mixture.

In one embodiment, the method of producing a whipped beverage concentrate can include dispensing the whipped beverage concentrate into a container including water, milk, cream, half and half, alcohol, non-dairy substitute, flavors, and/or other ingredients.

In one embodiment, the canister can include an aerosol canister, a keg, or a whipped cream canister.

In one embodiment, the canister containing the base mixture can be stored in a refrigerated environment.

In one example embodiment of a system for making a whipped beverage concentrate, the system can include a canister, wherein the canister is configured to receive a base mixture, the base mixture comprising at least two ingredients, and wherein the at least two ingredients includes an instant drink mix. The canister may be further configured to initiate release of nitrous oxide into the base mixture, thereby creating a whipped beverage concentrate, and to dispense the whipped beverage concentrate from the canister.

In one embodiment, the base mixture can include at least the instant drink mix and water. In one embodiment, the instant drink mix is at least one of an instant coffee, an instant espresso, a dehydrated chocolate or cocoa, a dehydrated tea, or another instant drink mix. In one embodiment, the instant coffee can include dehydrated brewed coffee, and the instant espresso can include dehydrated brewed espresso.

In one embodiment, the at least two ingredients can be dissolved or nearly dissolved in the base mixture.

In one embodiment, the canister can be further configured to dispense the whipped beverage concentrate from the canister into a container containing water, milk, cream, half and half, alcohol, non-dairy substitute, flavors, and/or other ingredients.

In one embodiment, the canister can include an aerosol canister, a keg, or a whipped cream dispenser.

In one embodiment of a whipped beverage composition, the composition may include a base mixture including at least an instant drink mix and water and nitrous oxide, wherein the nitrous oxide is mixed with the base mixture, thereby resulting in a whipped beverage concentrate.

In one embodiment, the instant drink mix is at least one of instant coffee, instant espresso, a dehydrated chocolate or cocoa, a dehydrated tea, or another instant drink mix.

In one embodiment, the base mixture can be received in a canister, and the canister can be configured to dispense the nitrous oxide into the base mixture. In one embodiment, the canister may include an aerosol canister, a keg, or a whipped cream dispenser.

In one embodiment, the base mixture can be dispensed into a container including water, milk, cream, half and half, alcohol, non-dairy substitute, flavors, and/or other ingredients.

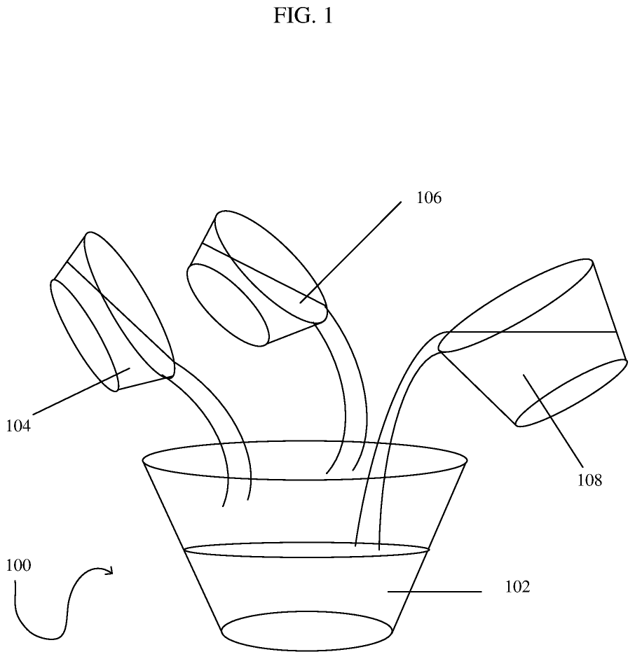

Turning to the figures, FIG. 1 illustrates an example composition and system for creating a mixture to make a whipped beverage concentrate 100, in accordance with an embodiment of the disclosure. As shown in FIG. 1, the example composition and system includes a base mixture 102. In some embodiments, the base mixture 102 can include instant coffee 104, water 106, optionally sugar 108, and optionally flavors and/or other ingredients. An example of another ingredient that may be added to the base mixture 102 is thickeners, such as carrageenan. In other embodiments, the instant coffee 104 can be replaced with a similar dehydrated ingredient or instant drink mix, such as, for example, instant espresso, instant hot chocolate, instant tea, or another dehydrated product. In some embodiments, the dehydrated ingredient or instant drink mix includes a substance that has been dehydrated through freeze-drying, spray-drying, or agglomeration. In some embodiments, the instant coffee 104 and the water 106 are added in equal parts to form the base mixture 102. In other embodiments, the instant coffee 104, the water 106, and the sugar 108 are added in equal parts to form the base mixture 102. In yet other embodiments, the instant coffee 104, the water 106, the sugar 108, and other optional flavors and/or other ingredients may be added in equal parts to form the base mixture 102. In some embodiments, the water 106 may be at boiling or near boiling temperature when used to form the base mixture 102.

In other embodiments, the instant coffee 104 (or other dehydrated ingredient or instant drink mix), the water 106, the optional sugar 108, and any optional flavors and/or ingredients can be mixed so that the base mixture 102 reaches a syrup-like consistency and/or the components in the base mixture 102 are nearly or fully dissolved such that no solids remain.

Although not depicted in FIG. 1, in some embodiments, the instant coffee 104 may be produced by first brewing coffee or espresso. Coffee may be brewed by pouring a proportional amount of water onto a proportional amount of ground coffee beans, and then allowing the coffee to brew. Espresso may be brewed by pouring a proportional amount of water onto a proportional amount of ground espresso beans, and then allowing the espresso to brew. In some embodiments, the brewing process may involve no additional equipment. In other embodiments, the brewing process may involve other additional equipment, such as a filter, a percolator, a French press, and/or any other equipment conventionally used to brew coffee.

In some embodiments, the instant coffee 104 (or instant espresso) may then be produced by subsequently dehydrating the brewed coffee or espresso. In some embodiments, the dehydration process may involve processes such as agglomeration, spray-drying, or freeze-drying. If agglomeration is used, the brewed coffee is gently agitated with an agglomerating fluid, such as water or steam. After a steam belt or steam curtain is applied, the coffee parties in the instant coffee 104 (or instant espresso) bind together, thus forming granules. If spray-drying is used, the brewed coffee or espresso is sprayed into hot and dry air to evaporate the water, which leaves behind only the dehydrated coffee particles. The spray-drying process further removes oils that were present in the brewed coffee, which contain non-polar molecules. If freeze-drying is used, the brewed coffee or espresso is concentrated and deep-frozen. The deep-frozen concentrated brewed coffee or espresso is then run through a low-pressure tube so that the frozen water in the brewed coffee or espresso undergoes a process known as sublimation, thus leaving behind dehydrated coffee granules. The freeze-drying method further preserves some aromatic compounds and oils that were present in the brewed coffee or espresso in order to retain the taste of coffee in the instant coffee 104.

Further, the instant coffee 104 (or instant espresso) is beneficial for producing a whipped coffee beverage because the instant coffee 104 lacks the oil compounds that are present in brewed coffee. For example, the spray-drying method removes the oils that contains non-polar molecules in brewed coffee or espresso. Unlike polar molecules, which contain a positively charged end and a negatively charged end, non-polar molecules do not contain a positively charged end and a negatively charged end. Generally, polar molecules interact well with other polar molecules, while non-polar molecules interact well with other non-polar molecules. In particular, amphiphilic molecules contain both polar and non-polar regions, which allows amphiphilic molecules to interact with both polar and non-polar substances. As an example, amphiphilic molecules that are found in proteins in instant coffee (such as the instant coffee 104 or instant espresso), can interact with both polar substances (for example, water) and non-polar substances (for example, oil).

In some embodiments, many proteins that are long folded chains of amino acids are amphiphilic. However, such proteins are often folded such that their non-polar components are tucked inwards and their polar components are faced outwards to interact with a polar environment. When such amphiphilic proteins undergo denaturing, they unfold and lose the ability to function. In some embodiments, denaturing may occur through physical force, for example, vigorous whipping, or exposure to air, for example, when air is whipped into a substance. As a result, the non-polar components, which are hydrophobic, are now exposed to the air in air bubbles during the whipping process, and the polar components, which are hydrophilic, are now exposed to the water surrounding the air bubbles during the whipping process. The denatured amphiphilic proteins then bond to each other to form a structure that stabilizes the air pockets created during the whipping process into a cream-like foam. The instant coffee 104 (or instant espresso) is thus preferable for producing a whipped coffee beverage because there are oils, proteins, and other amphiphilic compounds in brewed coffee or espresso, which may prevent the stabilization of the air pockets into the cream-like foam by interrupting the structure formed by the denatured proteins around the air bubbles during the whipping process. Thus, the use of brewed coffee for this process may cause the walls of the air bubbles to weaken, which renders them more likely to pop.

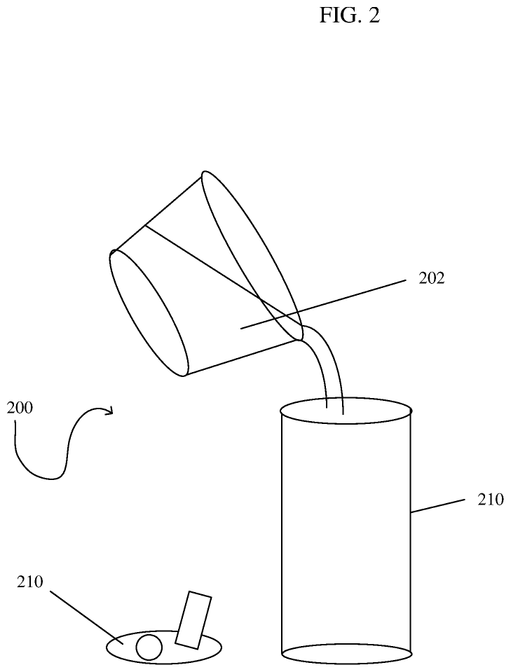

FIG. 2 illustrates another example system and apparatus 200 for loading a base mixture 202, for example, the base mixture 102 depicted in FIG. 1, into a canister 210, in accordance with an embodiment of the disclosure. In some embodiments, the canister 210 is a commercially-available canister that includes a nitrous oxide source, such as a charger. In some embodiments, the canister 210 is an aerosol canister. In some embodiments, the aerosol canister may be made of either steel or aluminum. In other embodiments, the canister 210 is a keg. In yet other embodiments, the canister 210 is a whipped cream dispenser or other similar product. In other embodiments, the base mixture 202 is poured into the canister 210 that is compatible with a nitrous oxide charger, which can be inserted into or adjacent to the canister 210, and initiated as needed to release nitrous oxide into the canister 210 and/or the base mixture 202 when needed. In other embodiments, the base mixture 202 is poured into the canister 210, pressurized with a separate source of compressed gas, such as nitrous oxide, and sealed for later use and storage. A charger can include, but is not limited to, an amount or quantity of compressed gas, such as nitrous oxide, or an internal or external component designed to dispense the compressed gas, which is suitable to input the compressed gas into the base mixture 202 as the base mixture 202 is dispensed from the canister 210, thereby causing a whipped beverage concentrate, such as the whipped beverage concentrate 100 depicted in FIG. 1, to be created and dispensed from the canister 210.

Although not depicted in FIG. 2, the canister 210 can be sealed and charged with the nitrous oxide charger prior to use.

Nitrous oxide is a suitable gas for use with a base mixture, for example, the base mixture 202, to make a whipped beverage concentrate. The use of nitrous oxide is particularly beneficial and solves a technical problem in making certain whipped beverages since the time to make such whipped beverages may be significantly reduced when compared to electric mixing or hand mixing the ingredients for such whipped beverages, all while retaining the whipped structure of a whipped beverage. Nitrous oxide is favored because it is more soluble than nitrogen and remains in its liquid state at a lower pressure of about 764 psi. The increased solubility of nitrous oxide allows the nitrous oxide to readily dissolve in the base mixture 102 when under pressure. When the pressure is released, the nitrous oxide becomes undissolved, thus creating bubbles in the base mixture 202 and helping to foam the base mixture 202 to up to four times the original liquid volume. Further, nitrous oxide adds a sweet taste to the base mixture 202, which can be beneficial when making a whipped beverage. Thus, when compared to other gases such as nitrogen, nitrous oxide is further preferable because of the sweet taste, the increased solubility of the nitrous oxide, the ability of the nitrous oxide to remain in liquid form at less extreme temperatures, the increased volume of the resulting mixture when foaming the base mixture 202, the increased safety of consumption, and a lower risk of explosion due to lower pressure within the canister 210.

The use of conventional canisters that are compatible with compressed gas chargers or sealed under pressure with a compressed gas within the canister has been limited to certain consumable foods, for example cream, to create, in this example, whipped cream, and have not been previously used to make a whipped beverage concentrate.

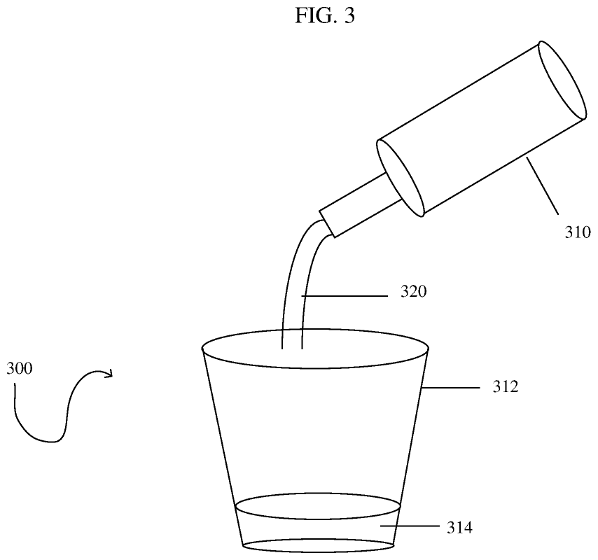

FIG. 3 illustrates yet another example system and composition for producing a whipped beverage 300 from a whipped beverage concentrate 320, such as the whipped beverage concentrate 100 depicted in FIG. 1, in accordance with an embodiment of the disclosure. In one embodiment, after a canister 310, for example, the canister 210 as depicted in FIG. 2, has been charged with nitrous oxide, the canister 310 can be shaken or otherwise manipulated, and a pressure release mechanism initiated, such as a squeezing or depressing a trigger, to release nitrous oxide from the charger into a base mixture, for example, the base mixture 102 as depicted in FIG. 1, and thereby dispense the whipped beverage concentrate 320 from the canister 310.

In one embodiment, the container used to dispense the whipped beverage 300 into can be a glass 312. In one embodiment, the glass 312 can contain water as a base liquid 314. In other embodiments, the glass 312 can contain milk, half and half, cream, non-dairy substitute, alcohol, and/or other liquid or ingredients that can alone or in combination form the base liquid 314 for mixing with the whipped beverage concentrate 320. In some embodiments, other flavors or ingredients may be added to the glass 312. In other embodiments, the glass 312 may further contain ice or another relatively cold or frozen component if a cold whipped beverage 300 is desired. In one embodiment, the canister 310 can dispense the whipped beverage concentrate 320 on top of the base liquid 314. In other embodiments, the base liquid 314 can be added to the glass 312 after the canister 310 has dispensed the whipped beverage concentrate 320. In some embodiments, other containers instead of a glass 312 may be used.

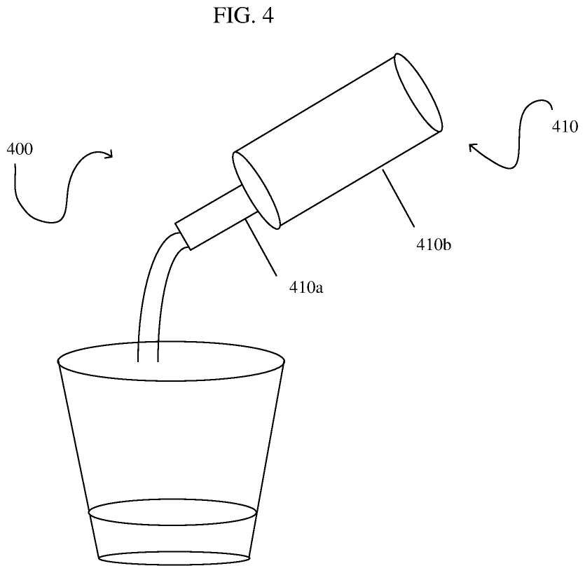

FIG. 4 illustrates an example system and composition for dispensing a whipped beverage concentrate 400 from a canister, in accordance with an embodiment of the disclosure. A canister 410 can dispense the whipped beverage concentrate 400 when a pressure release mechanism is initiated, thereby releasing nitrous oxide into a base mixture, for example, the base mixture 102 depicted in FIG. 1, to create a whipped beverage concentrate 400, for example, the whipped beverage concentrate 100 as depicted in FIG. 1. In some embodiments, after the canister 410 has been charged with nitrous oxide, the canister 410 may be shaken or otherwise manipulated, and the pressure release mechanism, for example, a squeezable trigger, may be initiated to release the nitrous oxide into the base mixture while under pressure. In some embodiments, after the nitrous oxide has been released into the base mixture under pressure, the canister 410 may be shaken or otherwise manipulated vigorously before the whipped beverage concentrate 400 may be dispensed from the canister 410. In some embodiments, the pressure release mechanism may include a handle 410A on the canister 410 or a movable nozzle tip, which may be manipulated in a direction, such as towards a canister body 410B, so as to initiate the release of pressure within a nitrous oxide source such as a nitrous oxide charger and/or the canister 410 and thereby causing the whipped beverage concentrate 400 to be dispensed from the canister 410.

Although not depicted, the canister 410 containing the base mixture can be stored and refrigerated under pressure for several weeks, and can be used upon demand to dispense the whipped beverage concentrate 400. In some embodiments, refrigeration may not be required, but may be recommended.

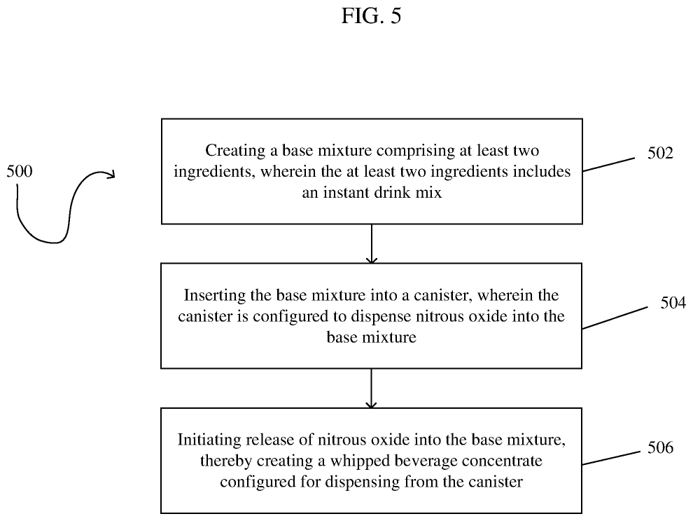

FIG. 5 illustrates a block flow diagram of an example method 500 for producing a whipped beverage concentrate, for example, the whipped beverage concentrate 100 depicted in FIG. 1, in accordance with an embodiment of the disclosure. At block 502, a base mixture including at least two ingredients is created. The at least two ingredients may include an instant drink mix. In some embodiments, the base mixture may include at least the instant drink mix and water. In some embodiments, the instant drink mix may be at least one of an instant coffee, an instant espresso, a dehydrated chocolate or cocoa, a dehydrated tea, or another instant drink mix. In some embodiments, the instant coffee may include dehydrated brewed coffee, and the instant espresso may include dehydrated brewed espresso. In some embodiments, the at least two ingredients may be dissolved or nearly dissolved in the base mixture.

At block 504, the base mixture may be inserted into a canister, wherein the canister is configured to dispense nitrous oxide into the base mixture. In some embodiments, the canister may include an aerosol canister, a keg, or a whipped cream dispenser. In some embodiments, the canister containing the base mixture may be stored in a refrigerated environment.

At block 506, release of nitrous oxide into the base mixture may be initiated, thereby creating a whipped beverage concentrate configured for dispensing from the canister. In some embodiments, the whipped beverage concentrate may be dispensed into a container including water, milk, cream, half and half, alcohol, non-dairy substitute, flavors, and/or other ingredients.

Unless otherwise noted, the terms used herein are to be understood according to conventional usage by those of ordinary skill in the relevant art. In addition to the definitions of terms provided below, it is to be understood that as used in the specification and in the claims, “a” or “an” can mean one or more, depending upon the context in which it is used.

Throughout this application, the term “include,” “include(s)” or “including” means “including but not limited to.” Note that certain embodiments may be described relating to a single glass, but the corresponding description should be read to include embodiments of two or more glasses. Different features, variations, and multiple different embodiments are shown and described herein with various details. What has been described in this application at times in terms of specific embodiments is done for illustrative purposes only and without the intent to limit or suggest that what has been conceived is only one particular embodiment or specific embodiments. It is to be understood that this disclosure is not limited to any single specific embodiments or enumerated variations. Many modifications, variations and other embodiments will come to mind of those skilled in the art, and which are intended to be and are in fact covered by this disclosure. It is indeed intended that the scope of this disclosure should be determined by a proper legal interpretation and construction of the disclosure, including equivalents, as understood by those of skill in the art relying upon the complete disclosure present at the time of filing.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

What has been described herein in the present specification and annexed drawings includes examples of systems, compositions, methods, devices, and techniques that, individually and in combination, permit the making of a whipped beverage concentrate. It is, of course, not possible to describe every conceivable combination of components and/or methods for purposes of describing the various elements of the disclosure, but it can be recognized that many further combinations and permutations of the disclosed elements are possible. Accordingly, it may be apparent that various modifications can be made to the disclosure without departing from the scope thereof. In addition, or as an alternative, other embodiments of the disclosure may be apparent from consideration of the specification and annexed drawings, and practice of the disclosure as presented herein. It is intended that the examples put forth in the specification and annexed drawings be considered, in all respects, as illustrative and not limiting. Although specific terms are employed herein, they are used in a generic and descriptive sense only and not for purposes of limitation.

1. A method for producing a whipped beverage concentrate, comprising:
creating a base mixture comprising at least two ingredients, wherein the at least two ingredients includes an instant drink mix;
inserting the base mixture into a canister, wherein the canister is configured to dispense nitrous oxide into the base mixture; and
initiating release of nitrous oxide into the base mixture, thereby creating the whipped beverage concentrate configured for dispensing from the canister.

2. The method of claim 1, wherein the base mixture comprises at least the instant drink mix and water.

3. The method of claim 1, wherein the instant drink mix is at least one of: an instant coffee, an instant espresso, a dehydrated chocolate or cocoa, a dehydrated tea, or another instant drink mix.

4. The method of claim 3, wherein the instant coffee comprises dehydrated brewed coffee, and wherein the instant espresso comprises dehydrated brewed espresso.

5. The method of claim 1, wherein the at least two ingredients are dissolved or nearly dissolved in the base mixture.

6. The method of claim 1, further comprising:
dispensing the whipped beverage concentrate into a container comprising water, milk, cream, half and half, alcohol, non-dairy substitute, flavors, and/or other ingredients.

7. The method of claim 5, wherein the canister comprises an aerosol canister, a keg, or a whipped cream dispenser.

8. The method of claim 1, wherein the canister containing the base mixture is stored in a refrigerated environment.

9. A system for making a whipped beverage concentrate, comprising:
a canister, wherein the canister is configured to:
receive a base mixture, the base mixture comprising at least two ingredients,
wherein the at least two ingredients includes an instant drink mix;
initiate release of nitrous oxide into the base mixture, thereby creating the whipped beverage concentrate; and
dispense the whipped beverage concentrate from the canister.

10. The system of claim 9, wherein the base mixture comprises at least the instant drink mix and water.

11. The system of claim 9, wherein the instant drink mix is at least one of: an instant coffee, an instant espresso, a dehydrated chocolate or cocoa, instant dehydrated tea, or another instant drink mix.

12. The system of claim 11, wherein the instant coffee comprises dehydrated brewed coffee, and wherein the instant espresso comprises dehydrated brewed espresso.

13. The system of claim 9, wherein the at least two ingredients are dissolved or nearly dissolved in the base mixture.

14. The system of claim 9, wherein the canister is further configured to:
dispense the whipped beverage concentrate from the canister into a container comprising water, milk, cream, half and half, alcohol, non-dairy substitute, flavors, and/or other ingredients.

15. The system of claim 9, wherein the canister comprises an aerosol canister, a keg, or a whipped cream dispenser.

16. A whipped beverage composition, comprising:
a base mixture comprising at least an instant drink mix and water; and
nitrous oxide, wherein the nitrous oxide is mixed with the base mixture, thereby resulting in a whipped beverage concentrate.

17. The composition of claim 16, wherein the instant drink mix is at least one of: instant coffee, instant espresso, a dehydrated chocolate or cocoa, a dehydrated tea, or another instant drink mix.

18. The composition of claim 16, wherein the base mixture is received in a canister, and wherein the canister is configured to dispense the nitrous oxide into the base mixture.

19. The composition of claim 18, wherein the canister comprises an aerosol canister, a keg, or a whipped cream dispenser.

20. The composition of claim 16, wherein the base mixture is dispensed into a container comprising water, milk, cream, half and half, alcohol, non-dairy substitute, flavors, and/or other ingredients.
